(19) United States
(12) Patent Application Publication
(10) Pub. No.: US 2014/0147346 A1
(43) Pub. Date: May 29, 2014

(54) LASER TREATMENT OF A MEDIUM FOR MICROFLUIDS AND VARIOUS OTHER APPLICATIONS

(71) Applicants: Girish Chitnis, Lafayett, IN (US); Babak Ziaie, West Lafayette, IN (US); Zhenwen Ding, Santa Clara, CA (US)

(72) Inventors: Girish Chitnis, Lafayett, IN (US); Babak Ziaie, West Lafayette, IN (US); Zhenwen Ding, Santa Clara, CA (US)

(21) Appl. No.: 13/818,081

(22) PCT Filed: Aug. 22, 2011
(86) PCT No.: PCT/US11/48695

§ 371 Date: Mar. 8, 2013

Related U.S. Application Data
(60) Provisional application No. 61/375,548, filed on Aug. 20, 2010.

(51) Int. Cl. B01L 3/00; B23K 26/08; B23K 26/36

(52) U.S. Cl. CPC B01L 3/502707; B23K 26/365; B23K 26/0807
USPC 422/502; 219/121.69; 219/121.78

(57) ABSTRACT

A patterned circuit, including a hydrophilic substrate, a hydrophobic layer formed on the hydrophilic substrate, and a pattern formed in the hydrophobic layer to expose the hydrophilic substrate.

### CROSS REFERENCE TO RELATED APPLICATIONS

The present application is related to, and claims the priority benefit of, U.S. Provisional Patent Application Ser. Nos. 61/375,548 filed Aug. 20, 2010, the contents of which is hereby incorporated in its entirety into the present disclosure.

### TECHNICAL FIELD

The present invention generally relates to generating patterns on a medium, and particularly to generating patterns for microfluidic and other various applications.

### BACKGROUND

There have been significant improvements in the field of microfluidics. Generally, fluids are directed from one location to another location within a microfluidic channel via a capillary action, gravity, or a pump. Microfluidic circuits may be part of microfluidic chips that are produced with high volumes. Exemplary features that are desirable in a microfluidic circuit include visual access to the channel and controlled flow rate.

In addition, there are applications where indicia are produced on a medium. The indicia may be produced when the medium is exposed to a specific environment, but the indicia are otherwise substantially hidden.

Furthermore, there are applications where a medium is used as a substrate for making conductive traces in an electronic or electrical circuit.

In all of the above cases, inexpensive and easy to manufacture solutions are desirable.

### SUMMARY

Different embodiments of a laser ablated substrate are described in the present disclosure that can be used in various applications such as but not limited to microfluidics, generating indicia, and providing conductive traces for use in a circuit. A hydrophilic substrate with a hydrophobic layer disposed thereon is used as a starting material. Areas of the hydrophilic layer on the substrate are ablated to expose the hydrophilic substrate. Ablation patterns are generated by a laser beam to produce the pattern on the material.

According to one aspect of the present disclosure, a patterned circuit is disclosed. The patterned circuit includes a hydrophilic substrate. The patterned circuit further includes a hydrophobic layer formed on the hydrophilic substrate. Furthermore, the patterned circuit includes a pattern formed in the hydrophobic layer to expose the hydrophilic substrate.

According to another aspect of the present disclosure, a method for patterning a circuit is disclosed. The method includes receiving a pattern for a circuit from a device. The method further includes storing the pattern in a memory. Furthermore, the method includes processing the stored pattern by a processor. Also, the method includes controlling a laser source by the processor based on the processed pattern. The method also includes ablating the pattern from a hydrophobic layer formed on a hydrophilic substrate, thereby exposing the hydrophilic substrate.

### BRIEF DESCRIPTION OF DRAWINGS

FIG. 1A depicts a fragmentary perspective view of a system for generating a microfluidic circuit, according to an embodiment of the present disclosure;

FIGS. 1B and 1C depict scanning electron microscopy (SEM) images of parchment paper for before (FIG. 1B) and after (FIG. 1C) laser ablation;

FIGS. 1D, 1E, 1F, and 1G depict X-ray photoelectron spectroscopy (XPS) analysis results on treated and untreated parchment paper.

FIGS. 2A and 2B depict exemplary embodiments where a substrate does not allow diffusion of fluid from various reservoirs to a mixing well (FIG. 2A) and another substrate which permits the diffusion (FIG. 2B);

FIGS. 2C, 2D, 2E, 2F depict SEM images of parchment paper before (2C and 2E) and after (2D and 2F) laser ablation treatment;

FIGS. 2G and 2H depict top views of laser ablated channels leading to a mixing well before (2G) and after (2H) placement of dyed water droplet on to each channel;

FIGS. 3A, 3B, and 3C depict exemplary embodiments, according to the present disclosure, where a substrate is used to generate indicia;

FIGS. 3D and 3E depict SEM images of high resolution array of lines (60 μm wide and 80 μm separation) generated by the laser ablation according to the present disclosure;

FIGS. 4A, 4B, 4C, 4D, 4E, and 4F depict additional exemplary embodiments, according to the present disclosure, where a substrate is used to generate indicia and various other patterns;

FIG. 5 depicts an exemplary embodiment according to the present disclosure wherein a substrate can be used to provide conductive traces for a circuit and other various applications;

FIG. 6 is a schematic of a manufacturing setup according to the teachings of the present disclosure;

FIGS. 7a, 7b, 7c, 7d, 7e, and 7f depict schematics of a paper with various process steps, according to the present disclosure;

FIGS. 8a and 8b depict schematic of pattered papers used for controlled deflection;

FIG. 9 is a schematic of using a laser in bonding of nonconductive porous substrate using wax melting;

FIG. 10 is a schematic of bonding alumina nanopore membranes over biochemical sensors fabricated on paper;

FIGS. 11a and 11b are schematics of self-assembly of electronic components on to laser treated paper;

FIGS. 12a and 12b are schematics of a 3D folding structure using stress-actuated paper microstructures;

FIG. 13 is a block diagram of a method of generating a pattern according to the present disclosure;

FIG. 14 is a schematic of cell culture and tissue engineering on paper based on patterns developed by the teaching of the present disclosure;

FIG. 15 is a schematic of an optical sensor using a paper with patterns developed based on the teachings of the present disclosure;

FIG. 16 is a schematic for an acoustic device using a paper with patterns developed based on the teachings of the present disclosure; and

FIG. 17 is a schematic for another acoustic device using a paper with patterns developed based on the teachings of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Different embodiments of a laser ablated substrate are described in the present disclosure that can be used in various applications such as but not limited to microfluidics, generating indicia, and providing conductive traces for use in a circuit. An economical and robust system is disclosed to generate patterns on a substrate using laser energy. A hydrophilic substrate with a hydrophobic layer disposed thereon is used as a starting material. Areas of the hydrophilic layer on the substrate are ablated to expose the hydrophilic substrate. Patterns are generated using a computer aided design (CAD) software. A laser generates a laser beam which follows the coordinates provided by the CAD software to produce the pattern on the material. The ablation process also forms micron sized fibrous structures which are highly hydrophilic. When exposed to an environment with high water content (or any other aqueous solution), the ablated areas retain water whereas water is rejected in other non-ablated areas. The hydrophilic nature of the ablated areas can be optimized by controlling energy level of the laser as well as the scanning speed of the laser. Various examples of hydrophilic substrates coated with hydrophobic layers are commercially available, e.g., wax paper. In the case of wax paper, after the ablation process and exposure to a high water content environment to generate a patterned paper, if the patterned paper is reheated, the wax in the un-ablated areas reflows to cover all the areas resulting in a continuous hydrophobic paper again. This process seals the pattern inside a layer of wax.

Apart from its basic application in print industry, paper has also been useful in other applications due to its fibrous nature, hydrophilicity, and good bonding capability with many chemicals (e.g., ink). For example, litmus impregnated paper strips for pH indication has been around for several hundred years. More recently, over-the-counter commercially available diagnostic tests for diabetes and pregnancy based on paper-strip assays (dipstick) have found widespread consumer appeal. Such chemical detection systems offer several important advantages such as ease of use, disposability, and low cost. Paper, apart from being cheap and easy to manufacture, is almost 100% cellulose, which is a renewable resource. Furthermore, it is compatible with most organic molecules, which makes it suitable for biochemical assays.

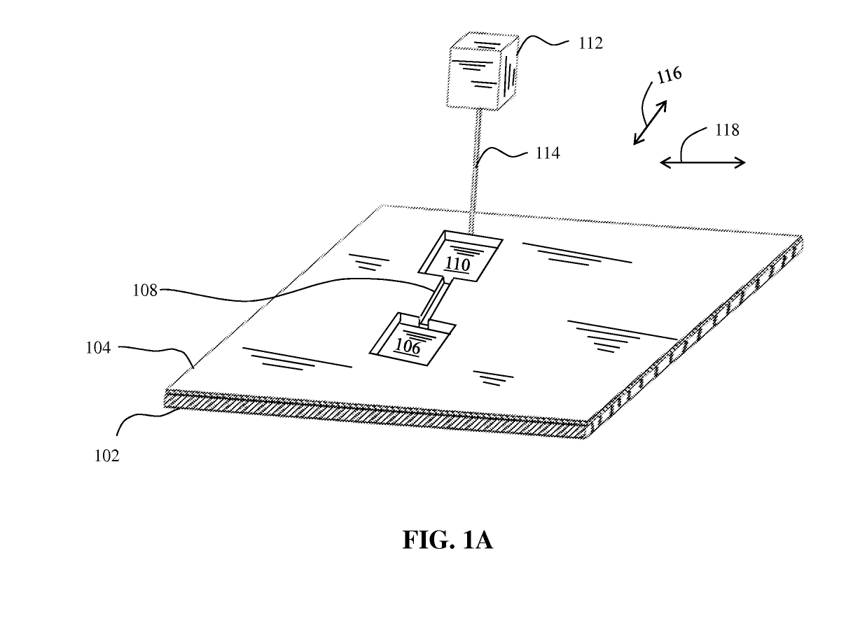

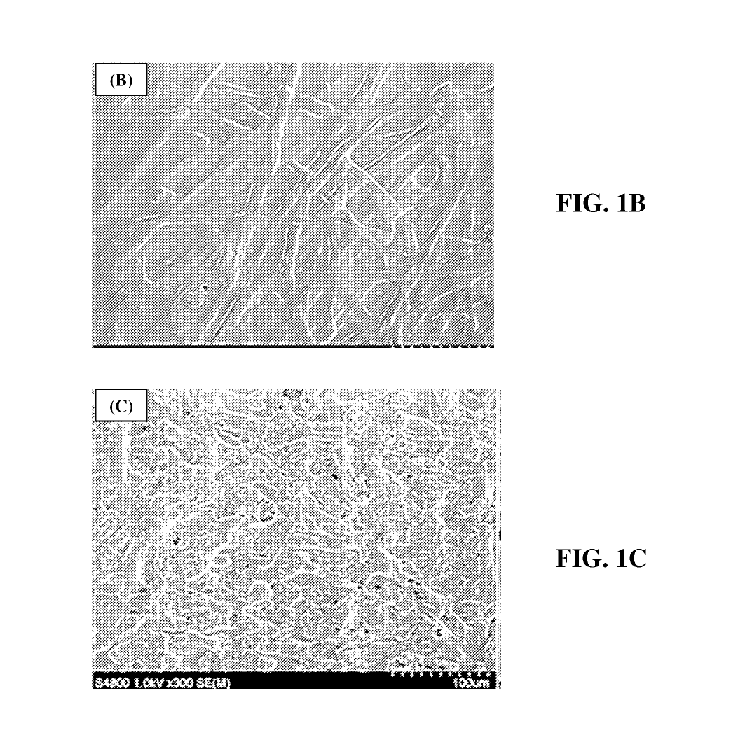

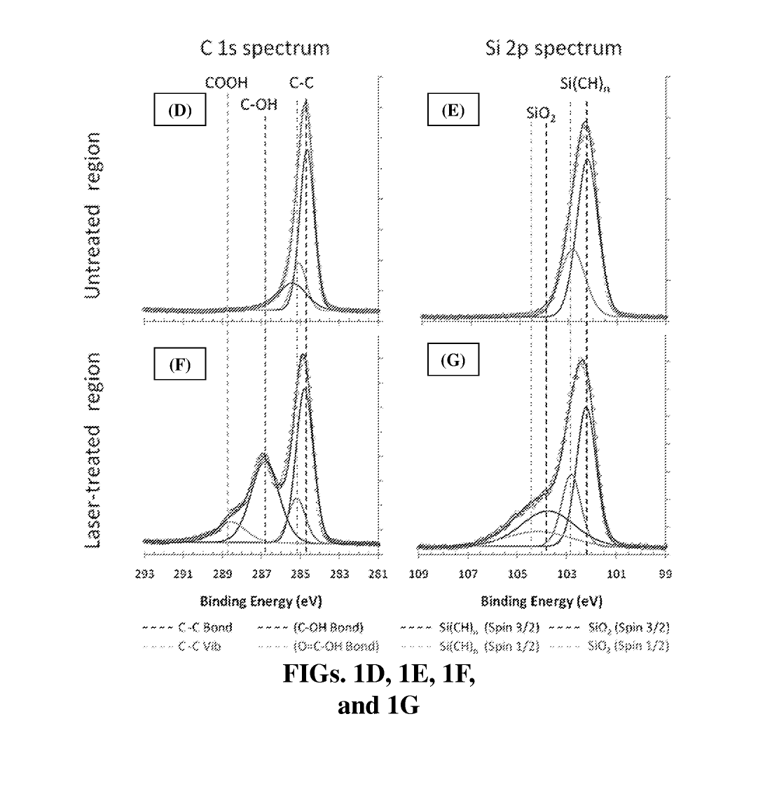

Referring to FIG. 1A, a system 100 is depicted that can be used to generate a microfluidic circuit. The microfluidic platform is based on a layer of silicone, wax or any other hydrophobic material, generally referred to as reference numeral 104 coated on a compressed fiber sheet 102 to produce a hydrophobic surface (coated paper). The coated paper can be placed on a planar surface and micromachined using a computer-controlled laser 112 that can be used for ablation of the coating 104. The microfluidics pattern can be generated using a CAD software. Exemplary patterns for a microfluidic circuit including reservoirs 106 and 110 and a microfluidic channel 108 are depicted in FIG. 1A. The laser 112, which can be a diode, CO₂, or neodymium-doped yttrium aluminum garnet (Nd:Y₃Al₅O₁₂, commonly referred to as Nd-YAG) laser source, generates a laser beam 114 which can generate the desired pattern when the laser moves about an X-Y coordinate system according to arrows 116 and 118. Higher source power for the laser 112 and slower speed generates deeper impressions into the compressed fiber sheet 102 (after removing the coating 104) and thereby generate a more hydrophilic surface. Therefore, in order to increase the hydrophilic aspect of the reservoirs 106 and 110 and the microfluidic channel 108, the laser ablation preferably penetrates with sufficient depth to reach the compressed fiber sheet 102 which is has hydrophilic attributes.

FIGS. 1B and 1C show Scanning electron microscopy (SEM) images of treated and un-treated parchment paper samples based on the system of FIG. 1A. The fibers in the parchment paper are clearly visible and protected by the surface coating on the non-treated areas (FIG. 1B). Since all the fibers are coated by silicone, the parchment surface is natively hydrophobic. Once the surface is laser-treated (FIG. 1C), the top silicone layer is modified increasing the surface roughness. Micro/nano scale cobweb structures on the surface are visible in higher magnifications.

Laser treatment is also known to cause changes in chemical properties of a substrate. FIGS. 1D-1G show raw and processed data from XPS analysis on the treated and un-treated parchment paper. Comparison of C1s spectra of untreated and laser-treated regions (FIGS. 1D and 1F, respectively) clearly reveals additional oxidation peaks in the treated regions. In fact, peaks corresponding to both C—OH (at 286.8 eV) and O═C—OH (at 288.6 eV) are prominent in treated regions. Similarly, Si2p spectrum of the treated region (FIG. 1G) shows the presence of Si—O bond (peak at 103.7 eV), which is not observed in the case of untreated regions (FIG. 1F). Peak observed at 102.2 eV is due to Si—C bonds present in the silicone. Although exposed cellulose fibers can also contribute to increased level of oxidized carbon in treated region, higher level of oxidized silicon (Si—O) definitely proves surface oxidation due to chemical reactions with atmospheric oxygen. Overall it is clear that laser treatment results in significantly more number of hydrophilic —OH, ═O groups at the surface. A combination of a highly fibrous structure formed due to melting/re-solidification and chemical surface modification allows the retention of water in the treated areas. Each type of paper provides advantages and challenges. For example, after laser ablation, parchment paper results in very sharp boundaries, however, wax paper does not. In contrast, in the case of wax paper, advantageously wax can be reflowed after patterning, thereby allowing patterned area to be covered with wax. Palette paper includes one side that is hydrophobic and one side that is hydrophilic and can offer a unique hybrid platform.

The effect of CO₂ laser on parchment paper using scanning electron microscopy was studied. Although other papers also become hydrophilic once laser-treated these other type of paper (e.g., wax paper, or palette paper) may not go through similar morphologic and chemical changes at a microscopic scale. Also, other commonly used lasers such as diode and Nd-YAG lasers might have some advantages and their interaction with materials on the surface could be different. Table 1 compares various properties of CO₂ Laser with diode laser, and Nd-YAG laser. Each laser has its unique wavelength resulting in different interaction with hydrophobic material coatings of various papers. They also have distinct machining capability (e.g., pulsed lasers have better machining capabilities compared to continuous wave lasers, mostly due to better thermal diffusion properties). Furthermore, excimer lasers operating at UV region have very specific interaction with polymeric material (these can ablate thin layers of polymeric films in a controlled manner).

TABLE 1
Comparison of different lasers used in surface treatment and machining of materials.

| Lasers | Type | Beam shape | power | Wave-length | Efficiency | Maintenance |
|---|---|---|---|---|---|---|
| CO₂ | Continuous | Very good | 50 W-10 kW | 10.6 μm | 15-25% | Robust laser |
| | | | | | | Specialty |
| | | | | | | mirrors/lenses needed |
| Nd-YAG | Pulsed | Multi-mode | (10-150 kW)* | 1.06 μm | 1-2% | Solid crystal easily |
| | | beam | | | | damaged, |
| | | | | | | Works with normal |
| | | | | | | optics |
| Diode | Continuous | Poor quality | ~0-10 W | Many choices | 50-60% | Good cooling needed |
| | or Pulsed | for high | | | | Compact and small |
| | | power | | | | set up |

*peak power avg. power is much lower

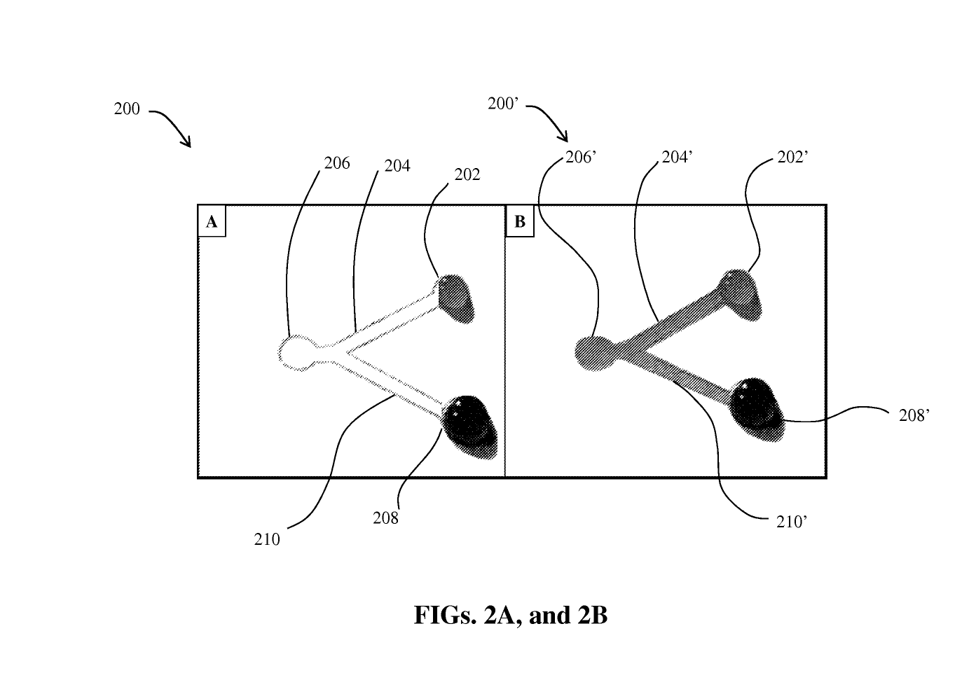

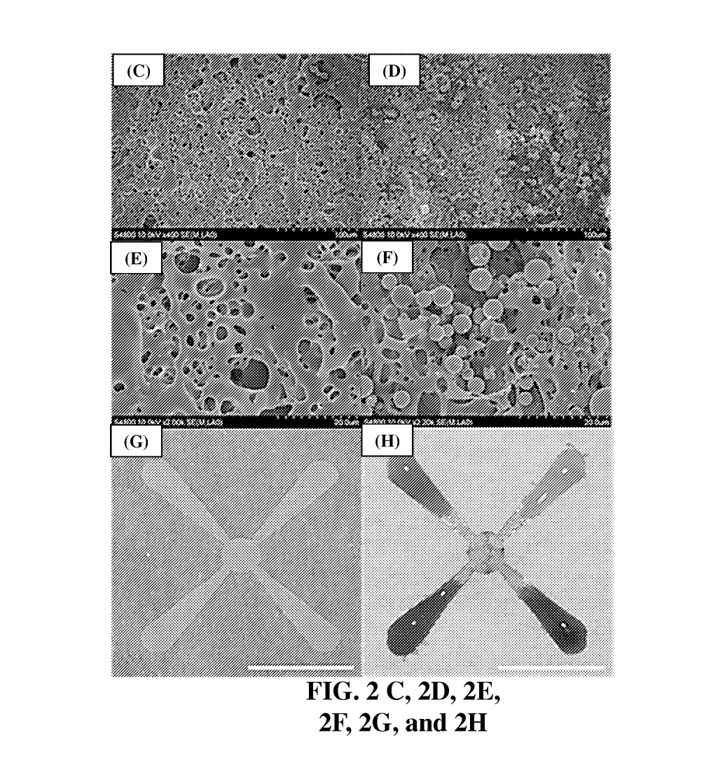

Referring to FIGS. 2A and 2B, exemplary microfluidic circuits 200 and 200′ are depicted. FIG. 2A depicts how the properties of hydrophobic areas depend on the type of paper compressed fiber sheet 102 that is used. The patterned circuit depicted in FIG. 2A includes a first reservoir 202, a first microfluidic channel 204, a mixing portion well 206, a second reservoir 208, and a second microfluidic channel 210. The microfluidic channels 204 and 210 are patterned on parchment paper which does not allow diffusion of water from the reservoirs 202 and 208 to the mixing well 206. Conversely, the microfluidic circuit depicted in FIG. 2B (including a first reservoir 202′, a first microfluidic channel 204′, a mixing portion well 206′, a second reservoir 208′, and a second microfluidic channel 210′) are patterned on a palette paper which allows the diffusion of water (a first colored water in the first reservoir 202′, the first microfluidic channel 204′ and a second colored water in the second reservoir 208′, and the second microfluidic channel 210′).

The diffusion capability of the paper has a long shelf-life. In order to test the shelf-life, a laser-patterned paper was tested after three weeks of its laser-patterning. The results showed no appreciable difference due to the three week storage.

According to another aspect of the present disclosure, silica microparticles can be selectively deposited on patterned area to enhance the lateral diffusion from one end of a channel to the other. FIGS. 2C, 2D, 2E, and 2F shows SEM images of laser treated areas before (2C, 2E) and after (2D, 2F) silica microparticle deposition. FIG. 2F clearly shows microparticles immobilized on top of the highly fibrous/porous structure. FIG. 2F shows an optical micrograph of patterned areas after microparticle deposition. FIG. 2G shows laser ablation of four reservoirs coming together to a central mixing well. FIG. 2H shows droplets of various dyed water that were placed at each of the four corners, thereby becoming mixed in the central mixing well due to diffusion along the channel. As can be clearly demonstrated by reviewing FIGS. 2B and 2H, the dyed water moves along the associated channels without diffusing on to the untreated areas about the channels.

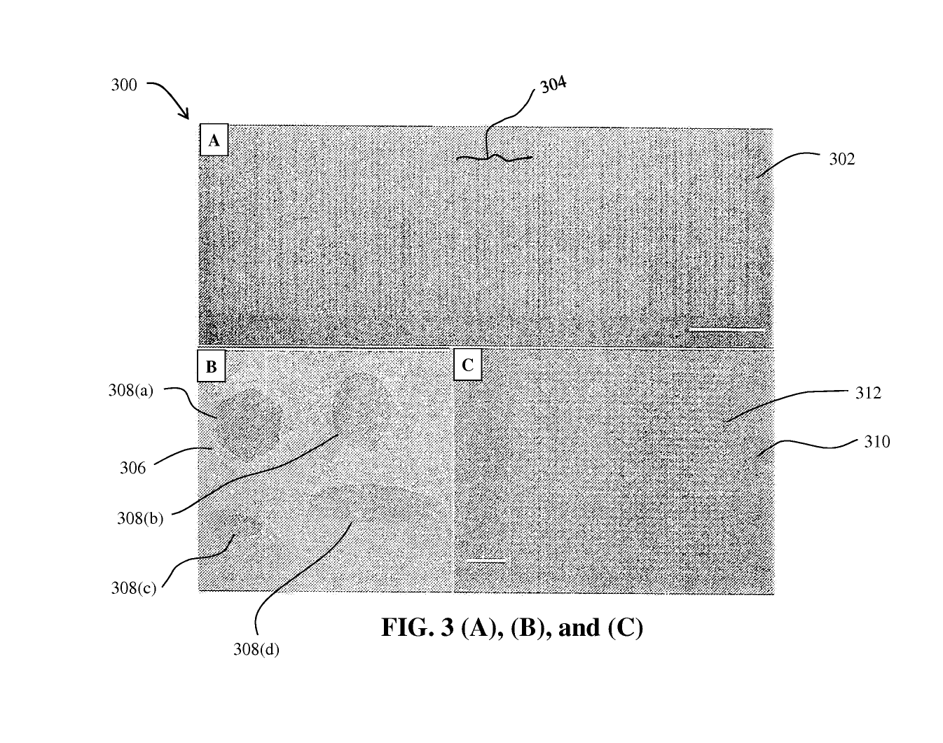

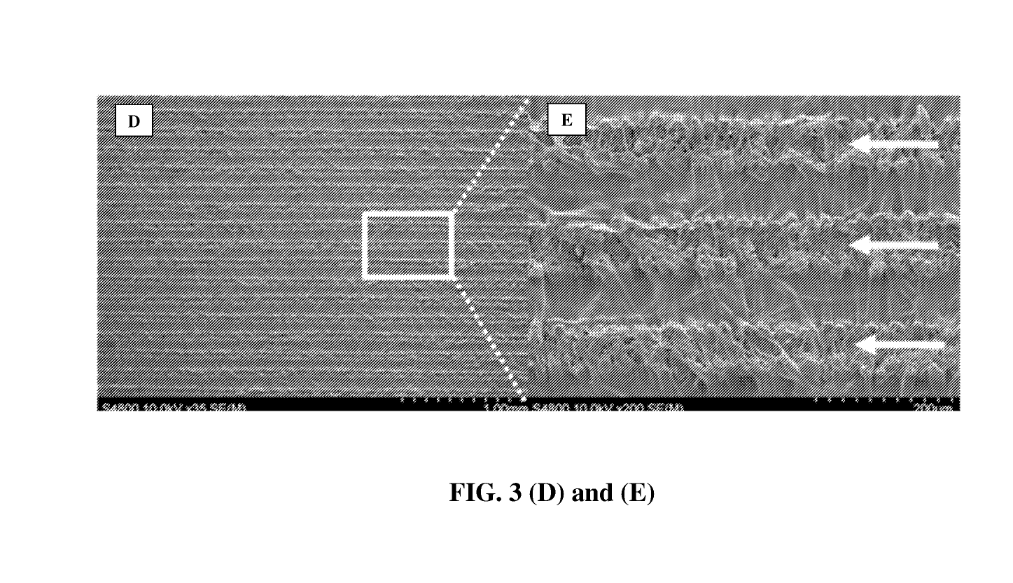

Referring to FIGS. 3A, 3B, and 3C, an indicia generating platform 300 is depicted. FIGS. 3A-3C show laser ablation on coated parchment paper 302, 306, and 310 with a large variety of geometries 304, 308(a), 308(b), 308(c), 308(d), and 312. Specifically, FIG. 3A depicts the fidelity of pattern transfer with a plurality of bar code patterns, FIG. 3B depicts various basic geometries, and FIG. 3C depicts a uniform and precise small dot array on a large area.

Referring to FIGS. 3D and 3E, SEM images of high resolution array of lines (60 μm wide and 80 μm separation) generated by the laser ablation according to the present disclosure are depicted. FIG. 3E shows a close up image of the white box in FIG. 3D.

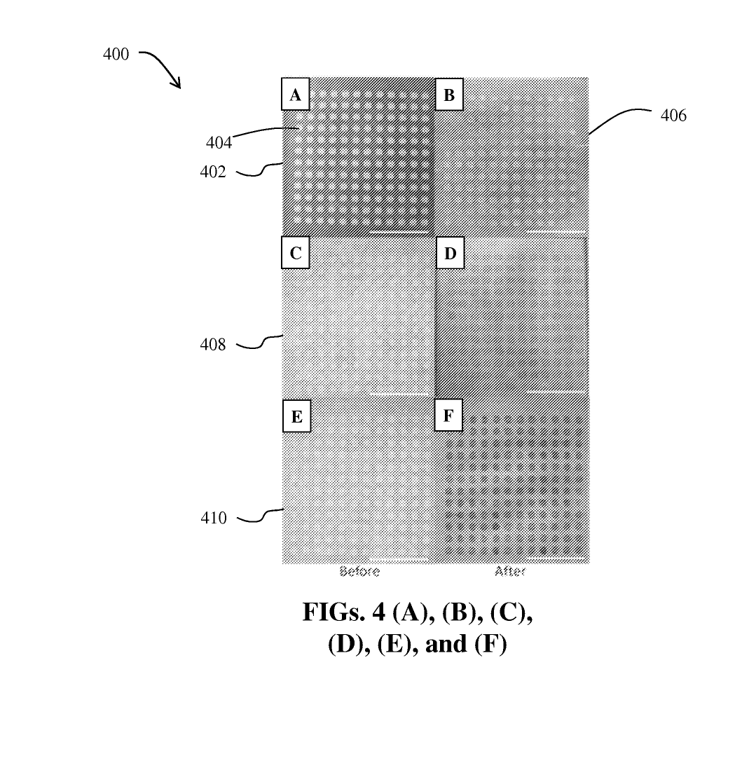

The system 100 can be easily adapted to generate patterns 400 on different types of papers. FIGS. 4A, 4B, 4C, 4D, 4E, and 4F depict the applicability of this system on several commercially available hydrophobic papers. Specifically, FIGS. 4A and 4B depict dot patterns 404 and 406 on wax paper 402, FIGS. 4C and 4D depict the same dot pattern 404 and 406 on palette paper 408, and FIGS. 4E and 4F depict the same dot pattern 404 and 406 on parchment paper 410. Each ablated paper is also depicted after being dipped into a reservoir of dyed water (dye was added to improve the contrast for easy photographing) with pattern side down. By slowly removing the parchment paper 410, dyed water can be uniformly deposited selectively on the laser-treated area on paper. FIGS. 4B, 4D, and 4F show the dyed water only deposited on the laser-patterned area while the untreated regions are free of any dyed water.

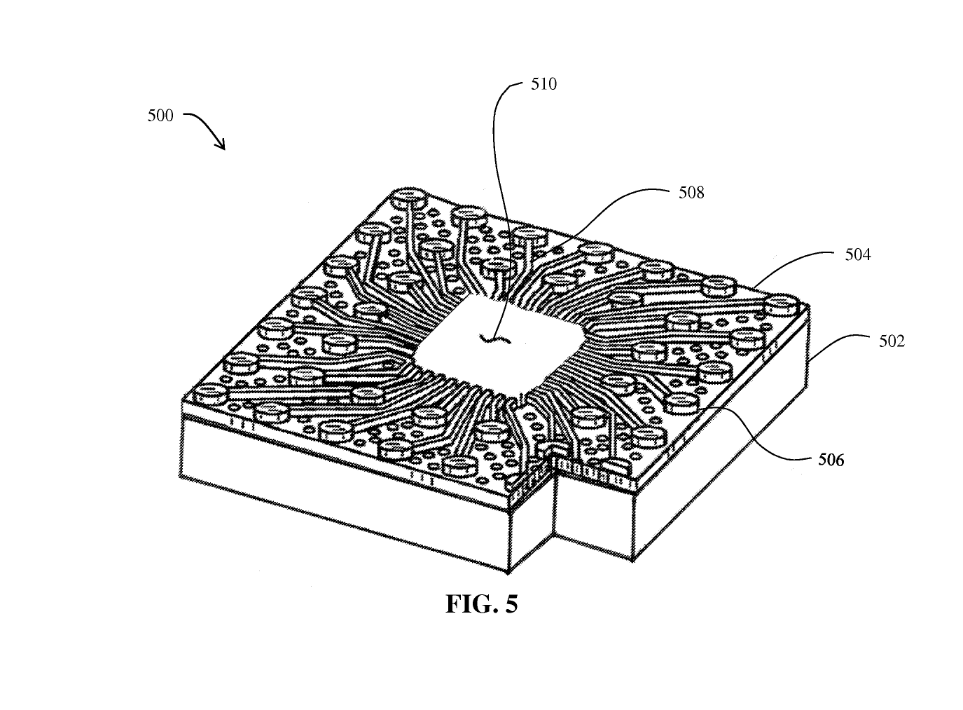

Referring to FIG. 5, an exemplary embodiment of conductive traces is depicted. In this embodiment a solution containing conductive material, e.g., water based solution containing gold nano-particles or a carbon grease compound, are used to fill the ablated areas. In the case of water based solution with conductive material, once the water evaporates, the conductive material, e.g., the gold nano-particles, remain in the patterned traces and provide the desired conductivity. In addition to gold nano-particles, other types of conductive materials such as tin, copper, silver, bismuth, indium, zinc, and antimony, or a combination of these material can be used. A quick wash with an organic solvent such as Isopropanol, removes particles from the non-patterned area, whereas particles trapped in fibrous structure remain and hence generate the desired pattern. The platform includes a fibrous substrate 502, and a hydrophobic layer 504. The pattern 500 includes pads 506 which are electrically connected to bond pads 508 which terminate at a landing area 510 for an integrated circuit.

While not shown, the reader should appreciate that multilayer structures are also possible with the system and method of the present disclosure. Each layer can be separately manufactured and laminated on to another layer in order to generate the multilayer structure. For example, while reservoirs (106 and 100) and microfluidic channel (108), depicted in FIG. 1A, or landing area 510, depicted in FIG. 5, are provided in a horizontal manner, several layers can be prepared and connected to each other in a vertical manner by a lamination process, with various features (e.g., reservoirs, microfluidic channels, landing areas, bon pads) connected in the vertical direction. For example, the reservoir 110 can be connected to another reservoir (not shown) separated vertically by vertical channels between the various layers. Therefore, a multilayer lab-on-paper can be generated by the system and method of the present disclosure for more compact distribution of the needed features. Similarly, a bond pad positioned on a first layer can be connected to another bond pad on a second layer that is vertically separated from the first layer by a channel similar to a via, known to a person of ordinary skill in the art. Multi-layer circuits are now common and necessary in today's complex electronics. Advantageously, the system and method of laser ablation according to these teachings provides a considerably less expensive path to generate the multilayer structure than in common in electronic manufacturing.

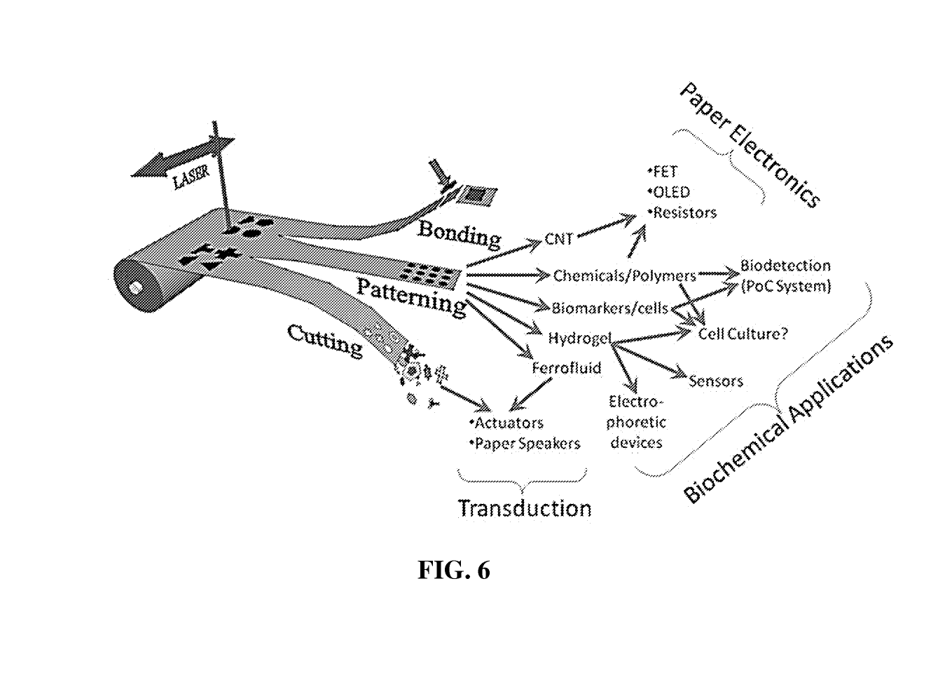

FIG. 6 shows a schematic of a laser-based manufacturing system for fabrication of multi-functional paper platforms. Such systems utilize both surface modification and micromachining capabilities of a laser. At low power levels the laser creates selective hydrophilic regions through surface treatment of hydrophobic papers while at an increased power levels the same laser can be used to cut the paper into the desired shape. This capability offered by the teachings of the present disclosure proposed is unique and can significantly reduce the costs of large scale manufacturing.

While not shown, a ferrite platform can also be used to generate a magnetic platform. Similar to the conductive trace platform, a colloidal solution of ferrite particles can be used to generate a desired magnetic pattern. This platform is demonstrated using colloidal solutions of ferrite nano-particles in a water insoluble hydrocarbon (ferrofluid). When a patterned paper is spread evenly with a ferrofluid, microfibrous structures trap suspended particles, thereby generating the desired magnetic pattern. As described above, a quick wash with an organic solvent such as Isopropanol, removes particles from the non-patterned area, whereas particles trapped in fibrous structure remain and hence generate the desired pattern. A barcode can be patterned using this platform. Vertical bars of the bar code can be used between terminals of a magnetic bar code reader to read information that is encoded in the bar code.

Another modification of the aforementioned laser patterning system can be used to entrap the coated material. Paper coated with low melting point hydrophobic material such as wax is suitable for such applications. After generating the desired patter with a laser and depositing water rich material on to the hydrophilic exposed areas, if the sample is reheated above the melting point of wax, wax reflows to cover the patterned area. This makes the patterned areas once again hydrophobic. Hence when the sample is dipped in water again, earlier pattern is not disturbed. This modification can be particularly useful for the ferrite platform wherein the magnetic bar code is sealed under the wax layer and can be preserved accordingly.

The system and method of laser ablation of a film according to the present disclosure provides platforms incorporating smart materials into the porous cellulose matrix which can have a broad impact in many areas including low-cost health care products, consumer/wireless electronics, and micro-robotics. In addition, such technologies also will be of immense benefit and utility in the developing world where biologically-derived materials are in abundance and whereas technological infrastructures are limited and scarce.

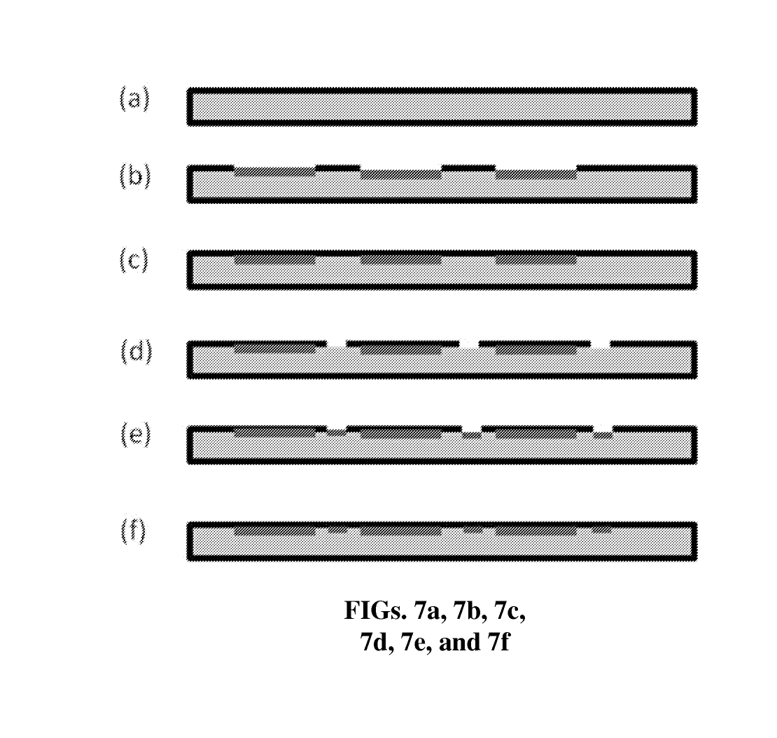

The laser patterning technique according to the present disclosure is versatile. Apart from paper fluidics, this method can be used to fabricate multi-functional platforms for various electronics, optics, and robotics applications. Paper can be impregnated with more than one material to provide a multifunctional paper. Surface patterned micro/nano-particles for biochemical applications need to be accessible. However, other applications incorporating physically active material such as ferrofluid, electrorheological fluid, conductive fluid, and liquid crystal would benefit from embedded structures that are surface protected. The reason is such a protection layer enhances the system functionality and lifetime by preventing general wear and tear of the pattern, as discussed above. This can be achieved for the patterns generated on the wax paper by simply reheating the sample. Molten wax tends to flow by capillary action and cover the laser treated areas, embedding the patterned regions. FIGS. 7a through 7f show the schematic of fabrication process for such paper. It is based on the resealing properties of wax paper. After one material is patterned in (FIGS. 7a-7b), the paper can be made completely hydrophobic by reheating it above wax-melting temperature (FIG. 7c). Subsequently, another material can be patterned on the same substrate. Hence a single platform can be embedded using magnetic nanoparticles (ferrofluid), electro-rheological fluid into microfluidic channels. It should be appreciated that fabricating such a multi-function platform using standard thin-film deposition and lithographic methods require multiple vacuum coating and making steps, whereas using the proposed method, such fabrication can be done extremely inexpensively and in a non-cleanroom environment.

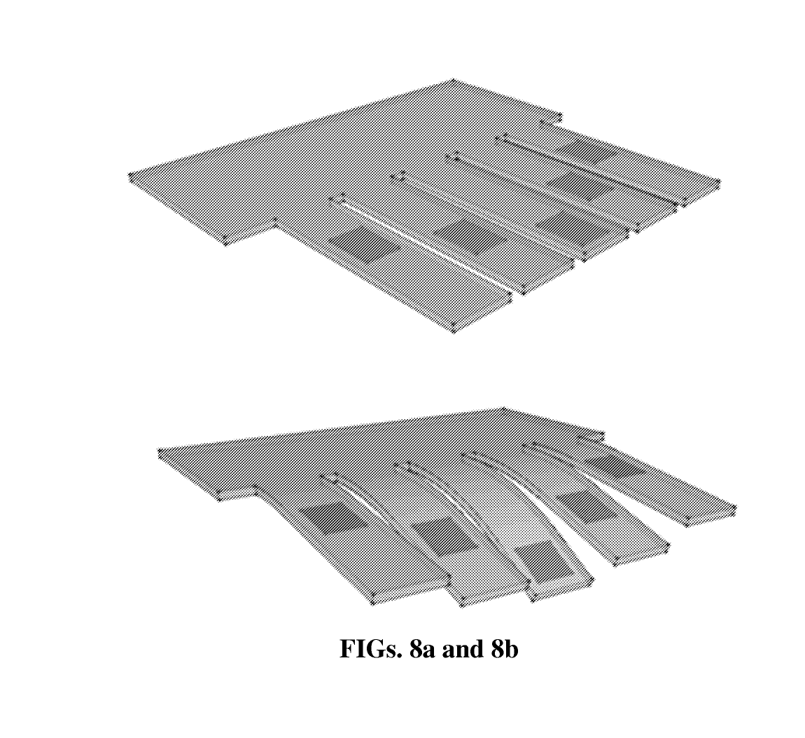

Referring to FIGS. 8a and 8b schematics of ferrofluid-embedded cantilevers with controlled deflection are depicted. Magnetic patterns based on laser surface treatment can be placed in desired areas to yield different deflection under a constant magnetic field, ferrofluid embedment, and paper micromachining. Such micro-cantilevers are ideal for biological applications since they can operate in aqueous environment and can apply small forces to soft biological materials.

The ability to embed/load colloidal particles (micro and nano) onto laser-treated hydrophobic papers depend on several factors such as the nature of the particles, their suspension medium (aqueous or non-aqueous), and their interaction with laser treated regions. Various related embodiments include embedding various magnetically (ferrofluid), electrically (electrorheological fluid, conductive inks, metallic nanoparticles, etc.), and optically (liquid crystals) active material in colloidal format onto different laser treated papers (parchment, wax, and palette).

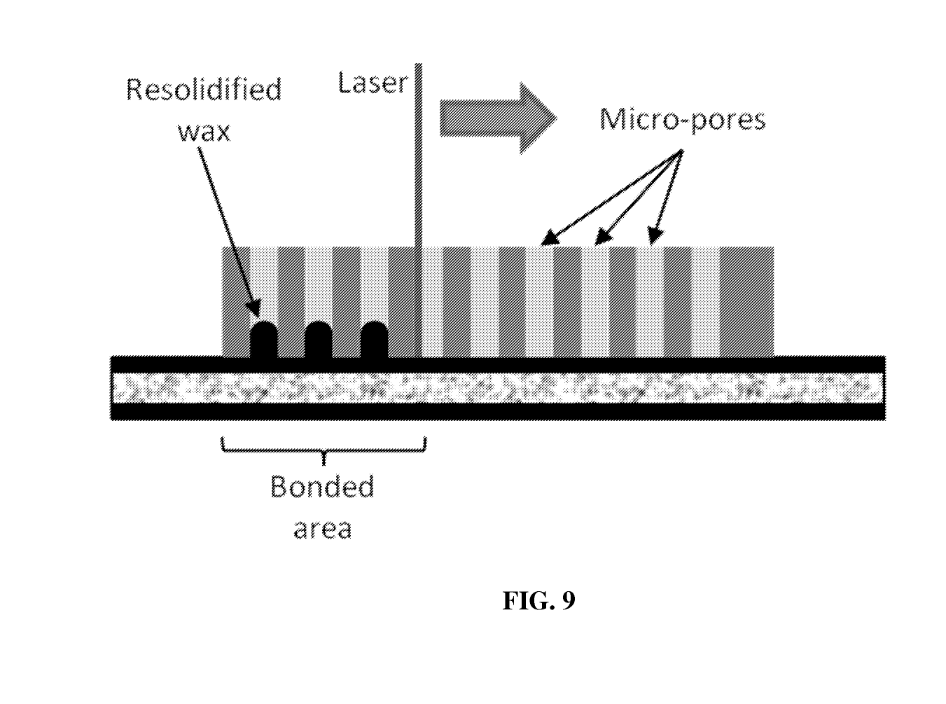

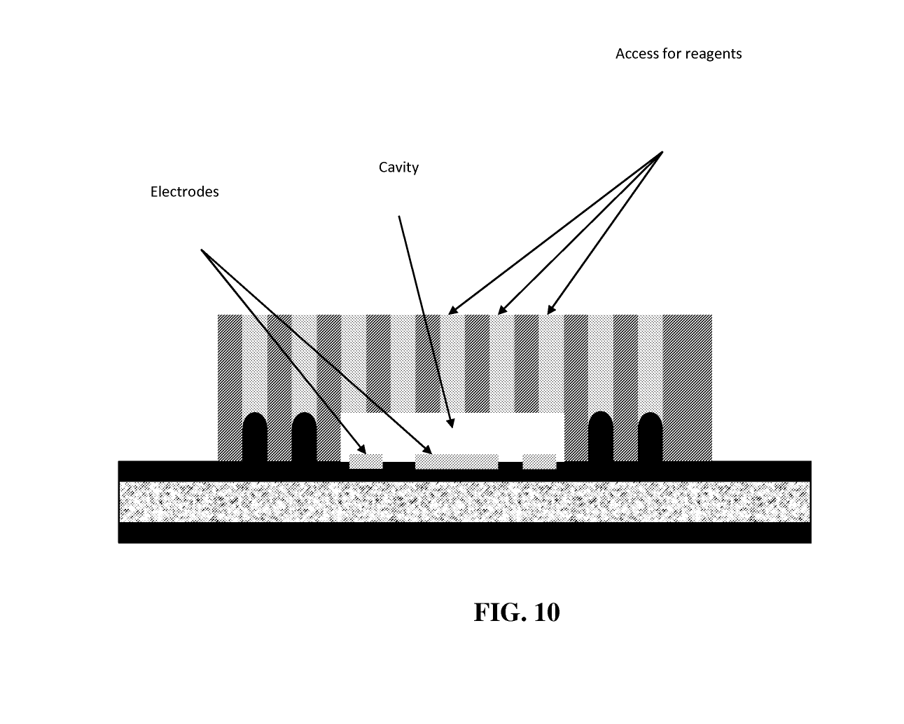

As discussed above, laser cannot only ablate the surface but it can also cut through when higher energies are used. This feature is advantageous where aligned cut around patterned surfaces are desired. This saves the alignment time since in a single step laser can pattern the surface and then cut wherever needed. For example in case of magnetic actuators, one can create ferrofluid-patterns and then cut out the cantilevers in a single step, resulting in the embodiment depicted in FIGS. 8a and 8b. Lasers are also used for welding materials. This is achieved by heating two pieces above their melting point and bringing them together. The same principle can also be applied to achieve paper bonding. For example, it is possible to join two pieces of wax paper by using optimum laser power. Also, one can bond solid rough/porous surfaces to wax paper as shown in FIG. 9. Molten wax tends to migrate to porous structure of a solid member and when solidified it provides microscopic mechanical locks, resulting in a high quality bond. For example, bonding alumina nanopore membranes over biochemical sensors fabricated on paper is depicted in FIG. 10. Such nanoporous barriers can be easily functionalized and provide a controllable access to the biosensor.

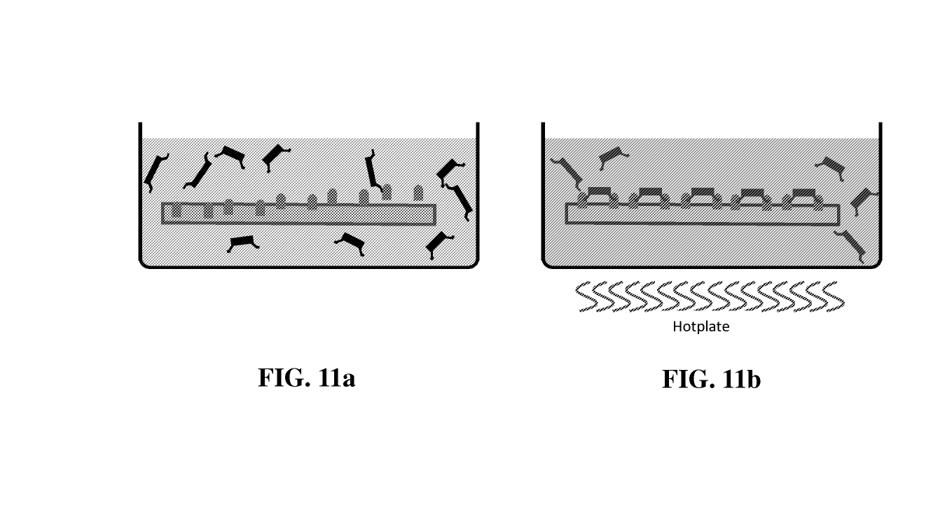

As discussed above, surface mount electronic devices (SMD) are good candidates for electronics fabricated on laser-treated hydrophobic papers. Such papers are well-suited for self-assembly of surface mount components due to the fact that paper hydrophobicity and its ability to withstand high temperatures would allow solder-based self-assembly. FIGS. 11a and 11b depict schematics of self-assembly of electronic components on to laser treated paper. Subsequent to laser-treatment of paper, hydrophilic regions are coated with solder and SMD components are self-assembled in liquid environment. In addition to solder, any one of tin, copper, silver, bismuth, indium, zinc, antimony or a combination of these materials can also be used.

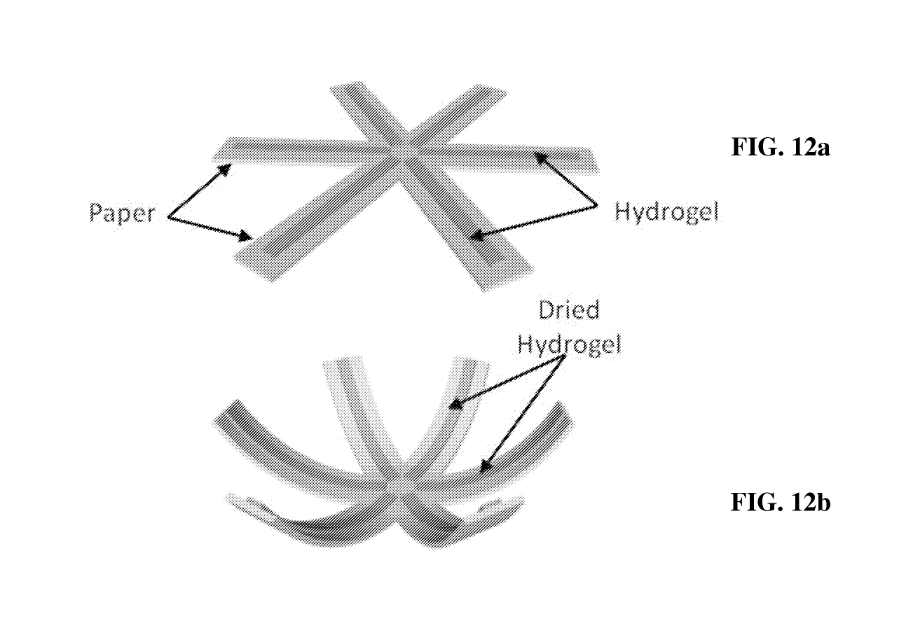

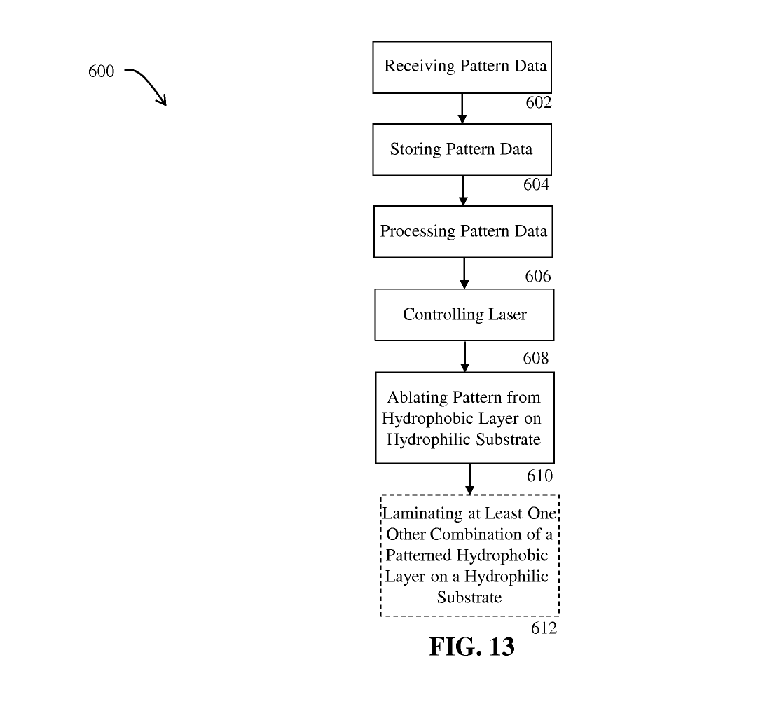

In addition, fabrication of self-folding structures on paper that can be used in such applications as autonomous-origami, can be achieved with the laser ablation of paper according to the present disclosure. Such structures can be accomplished in a number of ways. For example, one can embed ferrofluid in hinged structures and use a magnetic field to fold the paper into 3D configuration, e.g. as depicted in FIGS. 8a and 8b. Alternatively, hydrogel can be incorporated on to hydrophilic laser-treated areas and thereby use the stress created during the evaporation of water (hydrogel drying) to fold the paper. Such 3D structures are useful in a variety of microsystem applications such as micro-robotics, 3D actuators, and BioMEMS. FIGS. 12a and 12b depict a schematic of a 3D folding structure using stress-actuated paper microstructures.

Power requirements for a laser-based system can be quite low. In case of parchment paper, 15% of 120 W beam (i.e., 20 W) can be used. The spot size of this beam is about 60 μm in diameter hence power per unit area is about 7×10⁹ W/m². If the beam size is about 1 μm in diameter, power needed to achieve the same energy per unit area would be about 0.007 W; which is less than the power used by a laser used in a common compact disk (CD) writer. Hence by controlling the speed and power of the laser one can pattern paper using a CD writer. Although smaller beam size means longer scanning period for large patterns, portability of a battery-operated device based on a CD laser is advantageous. Further, if needed, it is possible to replace the low power laser in CD/DVD writers, with high power diode lasers that are commercially available. Power capacity of diode laser seems to be promising for the paper ablation; but we would need to develop new mounting methods.

Referring to FIG. 13, a block diagram for a method 600 of forming a circuit on a combination of a hydrophobic layer formed on a hydrophilic substrate is depicted. The method 600 includes receiving pattern data 602. The pattern data can be received from an external source, e.g., an external computer. The method 600 further includes storing the pattern data 604 in a memory. The method 600 further includes processing the pattern data 606 by a processor. The method 600 further includes controlling a laser 608 by the processor based on the stored pattern data. The method 600 also includes ablating the pattern 610 from a hydrophobic layer formed on a hydrophilic substrate, thereby exposing the hydrophilic substrate. The method 600 optionally includes laminating at least one other combination of a patterned hydrophobic layer on a hydrophilic substrate 612 in order to form a multilayer circuit.

While the embodiments related to microfluidics have been based on movement of an aqueous-based fluid from one reservoir (e.g., 106 depicted in FIG. 1) to another reservoir (e.g., 110) though a microfluidic channel 108 via capillary forces through the microfluidic channel 108, using reservoirs with opposite electrostatic charges can generate electrostatic pumping of the aqueous solution between two reservoirs 106 and 100. For example, the reservoir 106 may be charged with a positive voltage, while the reservoir 110 may be charged with a negative voltage. Each reservoir 106 and 110 may be referenced to a common ground (e.g., the substrate 102). Aqueous fluid in the reservoir 106 is therefore charged with the positive voltage, while the aqueous solution in the reservoir 110 is charged with the negative voltage. An electrostatic pumping action ensues between the two reservoirs moving the aqueous solution from one reservoir (e.g., 106) to the other (e.g., 110). The pumping action results in the movement of the fluid at a faster rate than by capillary action alone.

In accordance with another embodiment, an airborne particle detection scheme can be realized using the system and method discussed in the present disclosure. A reservoir (not shown) can be used to collect airborne charged particles, for the purpose of analysis. For example, the reservoir (not shown) can be charged with a positive voltage (again with respect to a ground, e.g., a substrate) for the purpose of collecting particles that are negatively charged. Similarly, a reservoir (not shown) can be charged with a negative voltage (again with respect to a ground, e.g., a substrate) for the purpose of collecting particles that are positively charged.

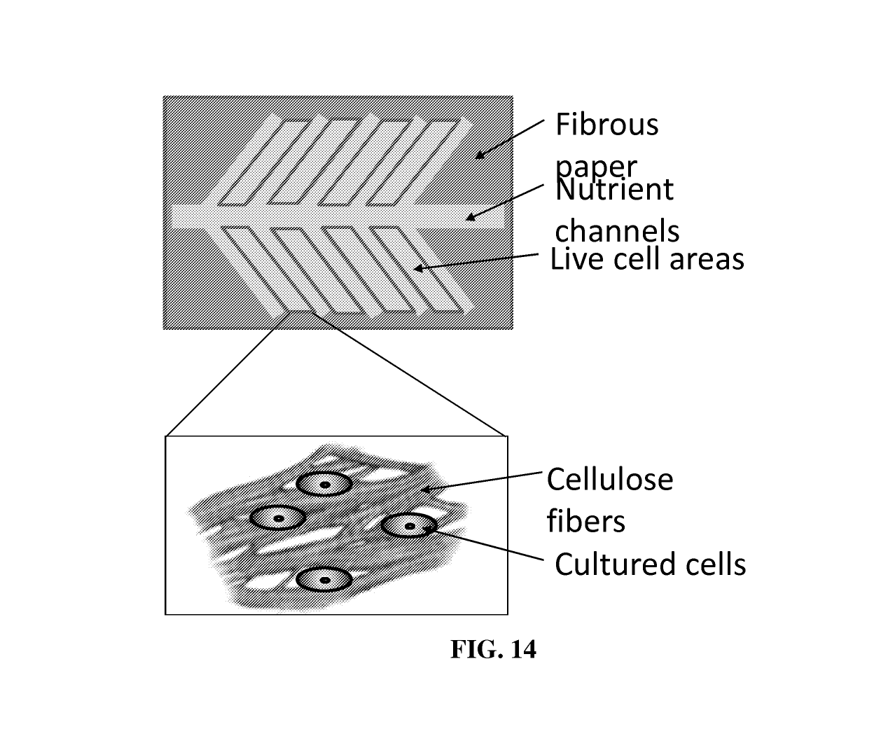

Referring to FIG. 14, a schematic of cell culture and tissue engineering on paper based on patterns developed by the teaching of the present disclosure is depicted. The patterned fibrous paper may be used for tissue engineering. Cellulose being a biocompatible material, can be used as a scaffold. Nutrient channels and cell growth areas can be patterned in an alternate fashion as shown in FIG. 14. The fibrous structure increases the surface area which provides cells more area to adhere. Additionally, the fibrous structure would also help in providing nutrients to these cell cultures. Since water can flow through these channels (e.g., due to capillary action), aqueous nutrients can be transferred from one end to the other. Further these thin sheets of paper can be stacked on top of each other to achieve 3D structures.

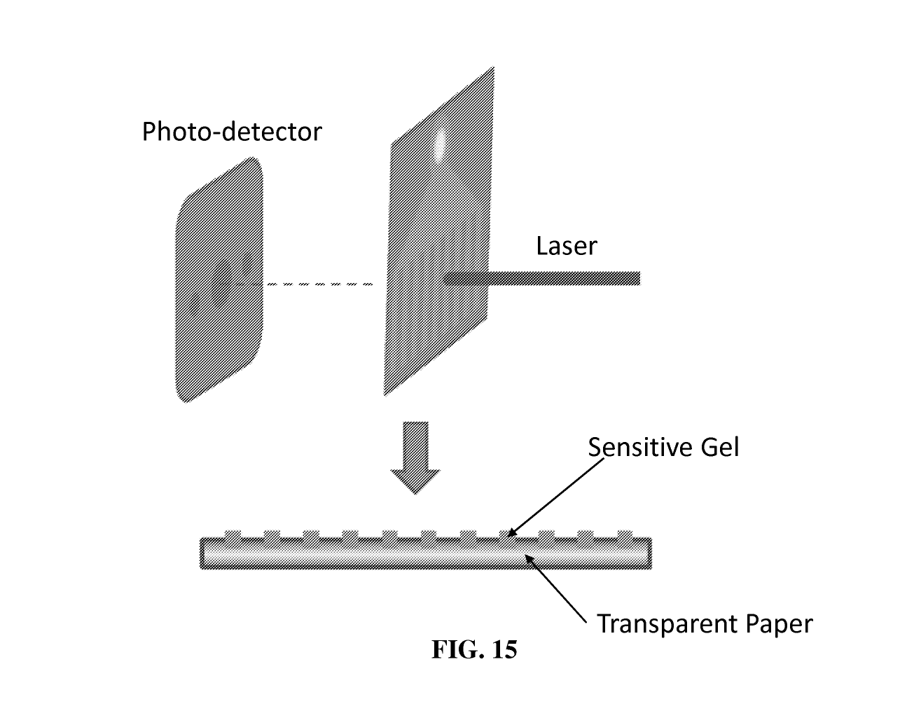

Referring to FIG. 15, a schematic of an optical sensor using a paper with patterns developed based on the teachings of the present disclosure is depicted. High energy laser is used to create hydrophilic/hydrophobic patterns on paper. Specifically, grating of chemical/temperature sensitive hydrogel can be developed. The hydrogel swells with environmental changes (e.g., chemical and temperature). Paper used in this case should be transparent or reflective. When a low energy laser is shined on the grating, it creates diffraction patterns as shown in FIG. 15 (while, only transparent paper is shown, a reflective paper can also be used in which case the photo-detector would be on the other side). This pattern would change, based on swelling of hydrogel. Overall, as environment change, the hydrogel swells, resulting in diffraction changes, which leads to photo-detection. Hence one can create optical sensors using the paper patterning technique disclosed in these teachings.

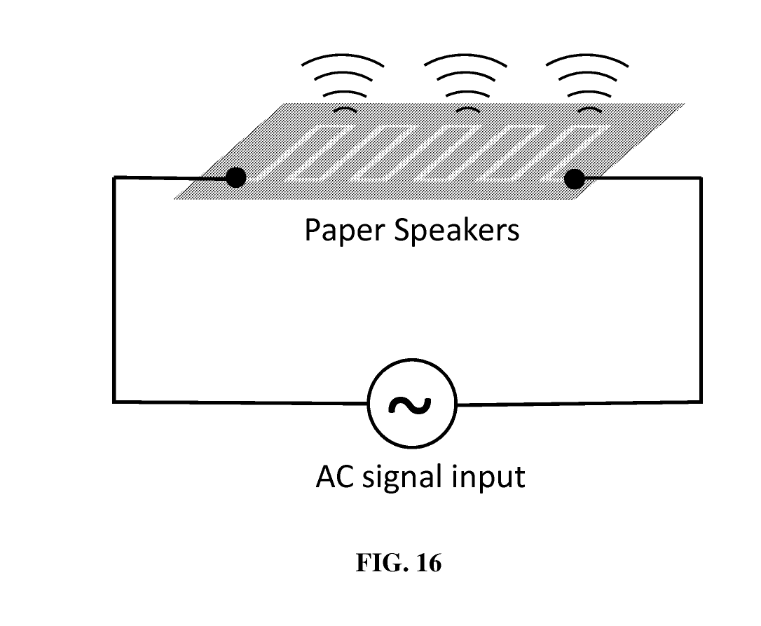

Referring to FIG. 16, a schematic for an acoustic device using a paper with patterns developed based on the teachings of the present disclosure is depicted. Carbon nanotubes or other conductive nanowires can be patterned on the paper using patterning technique discussed herein. When an alternating current (AC) signal is applied across the patterned paper, air expands close to the paper due to Joule heating. Continuous expansion and contraction results in a sound wave. As a result, a paper-speaker can be generated based on the teaching of the present disclosure.

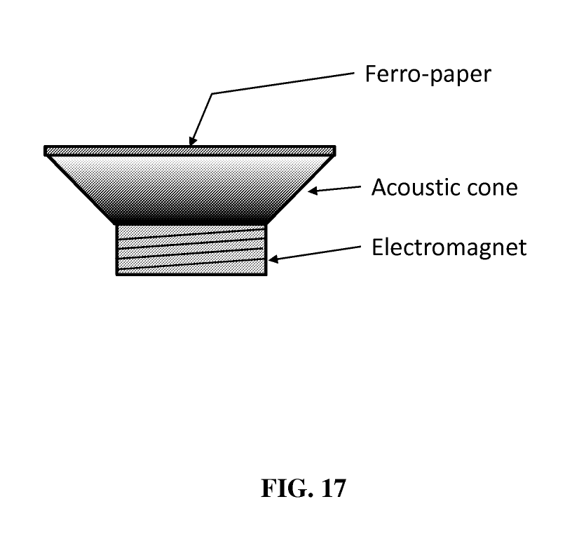

Referring to FIG. 17, a schematic for another acoustic device using a paper with patterns developed based on the teachings of the present disclosure is depicted. Specific magnetic patterns can be generated using ferrofluid patterns. Movement of the paper-membrane can be controlled by electromagnet. FIG. 17 shows the schematic of this device. The device depicted in FIG. 17 can be used as speaker as well as a microphone. While being used as a speaker, paper-membrane vibrates based on input electrical signal to generate sound, whereas while being used as microphone, the paper-membrane vibrates due to sound waves being received, thereby altering the magnetic field of electromagnet.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A patterned circuit, comprising:
a hydrophilic substrate;
a hydrophobic layer formed on the hydrophilic substrate; and
a pattern formed in the hydrophobic layer to expose the hydrophilic substrate.

2. The patterned circuit of claim 1, wherein the pattern is an ablation pattern formed by a laser.

3. The patterned circuit of claim 2, wherein the laser is one of a diode, carbon dioxide (CO₂), and neodymium-doped yttrium aluminum garnet (Nd-YAG).

4. The patterned circuit of claim 2, wherein the pattern is generated by a computer aided design software, and the laser is configured to automatically generate the pattern under control of software.

5. The patterned circuit of claim 1, wherein the pattern defines a microfluidic circuit.

6. The patterned circuit of claim 5, the pattern is configured such that when the pattern is exposed to an aqueous solution, the patterned portions retain the aqueous solution whereas the non-patterned portions reject the aqueous solution.

7. The patterned circuit of claim 1, wherein the pattern defines an electronic circuit.

8. The patterned circuit of claim 7, wherein the patterned portions are lined with a conductive material.

9. The patterned circuit of claim 8, wherein the conductive material is one or a combination of gold, tin, copper, silver, bismuth, indium, zinc, antimony.

10. The patterned circuit of claim 7, the pattern is configured such that when portions of the pattern are exposed to a binding agent, the portions retain the binding agent whereas the non-patterned portions reject the binding agent.

11. The patterned circuit of claim 10, wherein the binding agent is a soldering material including one or a combination of tin, copper, silver, bismuth, indium, zinc, antimony.

12. The patterned circuit of claim 1, wherein the hydrophilic substrate is a compressed fiber sheet.

13. The patterned circuit of claim 1, wherein the combination of the hydrophilic substrate and the hydrophobic layer is a parchment paper.

14. The patterned circuit of claim 1, wherein the combination of the hydrophilic substrate and the hydrophobic layer is a wax paper.

15. The patterned circuit of claim 1, wherein the combination of the hydrophilic substrate and the hydrophobic layer is a palette paper.

16. The patterned circuit of claim 1, further comprising:
at least one other combination of a second hydrophilic substrate and a second hydrophobic layer formed on the second hydrophilic substrate; and
a second pattern formed in the second hydrophobic layer to expose the second hydrophilic substrate, wherein the combination of the second hydrophobic layer and the second hydrophilic substrate is laminated on to the combination of the hydrophobic layer and the hydrophilic substrate to form a multi-layer circuit.

17. The patterned circuit of claim 16, wherein the second pattern is coupled to pattern.

18. The patterned circuit of claim 17, wherein the coupling between the pattern and the second pattern is a fluid coupling.

19. The patterned circuit of claim 17, wherein the coupling between the pattern and the second pattern is an electrical coupling.

20. A method for patterning a circuit, comprising:
receiving a pattern for a circuit from a device;
storing the pattern in a memory;
processing the stored pattern by a processor;
controlling a laser source by the processor based on the processed pattern; and
ablating the pattern from a hydrophobic layer formed on a hydrophilic substrate, thereby exposing the hydrophilic substrate.

21. The method of claim 20, wherein the laser is one of a diode, carbon dioxide (CO₂), and neodymium-doped yttrium aluminum garnet (Nd-YAG).

22. The method of claim 20, wherein the pattern defines a microfluidic circuit.

23. The method of claim 22, the pattern is configured such that when the pattern is exposed to an aqueous solution, the patterned portions retain the aqueous solution whereas the non-patterned portions reject the aqueous solution.

24. The method of claim 20, wherein the pattern defines an electronic circuit.

25. The method of claim 24, further comprising:
lining the patterned portions with a conductive material.

26. The method of claim 25, wherein the conductive material is one or a combination of gold, tin, copper, silver, bismuth, indium, zinc, antimony.

27. The method of claim 26, further comprising:
exposing the patterned portions and the non-patterned portions to a binding agent, wherein the patterned portions retain the binding agent and whereas the non-patterned portions reject the binding agent.

28. The method of claim 27, wherein the binding agent is a soldering material including one or a combination of tin, copper, silver, bismuth, indium, zinc, antimony.

29. The method of claim 20, wherein the hydrophilic substrate is a compressed fiber sheet.

30. The method of claim 20, wherein the combination of the hydrophilic substrate and the hydrophobic layer is a parchment paper.

31. The method of claim 20, wherein the combination of the hydrophilic substrate and the hydrophobic layer is a wax paper.

32. The method of claim 20, wherein the combination of the hydrophilic substrate and the hydrophobic layer is a palette paper.

33. The method of claim 20, further comprising:
receiving at least one other pattern for a circuit from the device;
storing the at least one other pattern in the memory;
processing the at least one other stored pattern by the processor;
controlling the laser source by the processor based on the at least one other processed pattern; and
ablating the at least one other pattern from at least one other hydrophobic layer formed on at least one other hydrophilic substrate, thereby exposing the at least one other hydrophilic substrate.

34. The method of claim 30, further comprising:
coupling the pattern to the at least on other pattern.

35. The method of claim 34, wherein the coupling between the pattern and the at least one other pattern is a fluid coupling.

36. The method of claim 34, wherein the coupling between the pattern and the at least one other pattern is an electrical coupling.
